(19) United States
(12) Patent Application Publication
(10) Pub. No.: US 2024/0269583 A1
(43) Pub. Date: Aug. 15, 2024

(54) FILTER ASSEMBLY WITH FILTER ELEMENT ENDCAP HAVING INTEGRAL EXTERNAL ROUNDED POLYGON SHAPED SEALING SURFACE

(71) Applicant: Schroeder Industries, LLC, Leetsdale, PA (US)

(72) Inventor: Matt Adams, Pittsburgh, PA (US)

(21) Appl. No.: 18/583,824

(22) Filed: Feb. 21, 2024

Related U.S. Application Data
(63) Continuation of application No. 16/599,272, filed on Oct. 11, 2019, now abandoned.
(60) Provisional application No. 62/744,156, filed on Oct. 11, 2018.

(51) Int. Cl. B01D 29/15; B01D 29/52; B01D 29/96

(52) U.S. Cl. CPC B01D 29/15; B01D 29/52; B01D 29/96; B01D 2201/043; B01D 2201/296; B01D 2201/304; B01D 2201/305; B01D 2201/4061

(57) ABSTRACT

A filter assembly includes a cylindrical filter housing, a filter element housing plate positioned between a high pressure and a low pressure side of the filter housing, the filter element housing plate having a plurality of one female cavities, and a plurality of replaceable filter elements within the filter housing. Each replaceable filter element has an endcap with an external rounded polygon shaped sealing surface engaging peripheral surfaces of an associated female cavity of the filter element housing plate and sealing against peripheral surfaces of the female cavity of the filter element housing plate.

### RELATED APPLICATIONS

This application is a continuation of U.S. patent application Ser. No. 16/599,272 titled “Filter Assembly with Endcap Having Integral External Rounded Polygon Shaped Sealing Surface” filed Oct. 11, 2019 which application is incorporated herein by reference in its entirety. U.S. patent application Ser. No. 16/599,272 claims priority to U.S. Patent Application Ser. No. 62/744,156 filed Oct. 11, 2018, titled “Filter Assembly with Endcap Having Integral External Rounded Polygon Shaped Sealing Surface” which application is incorporated herein by reference in its entirety.

### BACKGROUND INFORMATION

### 1. Field of the Invention

The present invention relates to filter assemblies, and more particular to a filter assembly with filter element endcap having integral external rounded polygon shaped sealing surface.

### 2. Background Information

Filtration systems are traditionally considered a fluid treatment and can also be considered as a part of contamination management. Contamination management is defined herein as relating to the analysis and optimization of processes with regard to the cleanliness of components, systems and the purity of the fluids used. In the hydraulics and mobile hydraulics industries smaller, lighter and more powerful components are currently being used compared to only a decade ago. The use of these components also results in that the demand of system cleanliness is now much higher, as has been shown by various studies. As much as 90% of all hydraulic system outages are due to increased contamination. This failure rate applies to more than classic hydraulics industry. Contamination management, such as through the design and implementation of appropriate filter assemblies, is a key issue in the design and maintenance of hydraulic or fluid power systems used in a general sense for all industries.

In general, filtration systems include i) disposable units in which the filtration media and housing are integrated into a single use unit, often called “spin-ons” due to a commonly implemented threaded attachment technique; ii) filter assemblies having replaceable units in which the filtration media is formed in a filter element (AKA a filter cartridge) that can be removed from a unit housing forming a filter assembly; and iii) filtration units with cleanable media, which can be cleaned with a process such as back-flushing.

Thus a filter element, also called a filter cartridge, within the meaning of this application, is a unit including filter media that is configured to be received in a filter assembly housing, sometimes referenced as a drop in element. The filter assembly is one, or more, filter housings and associated filter elements together with other components of the unit such as a control, test points, particle counters, bypass valves, etc.

The maintenance of a filter assembly having replaceable filter elements obviously requires the periodic replacement of the filter elements. Access to the replaceable filter elements is required, preferably in a simple fashion. Some filter assemblies include a plurality of filter elements and simple reliable access is important for efficient maintenance.

There is a need for a cost effective, efficient, filter assembly with simple filter housing access.

### SUMMARY OF THE INVENTION

This invention is directed to a cost effective, efficient, filter assembly with filter element endcap(s) having integral external rounded polygon shaped sealing surface.

One aspect of the invention provides a filter assembly including a filter element housing plate positioned between a high pressure and a low pressure side of the assembly and the filter element housing plate having at least one female cavity; at least one replaceable filter element within the filter assembly, each replaceable filter element having an endcap with an external rounded polygon shaped sealing surface engaging peripheral surfaces of an associated female cavity of the filter element housing plate and sealing against peripheral surfaces of the female cavity of the filter element housing plate.

One aspect of the invention provides filter assembly includes a filter element housing plate positioned between a high pressure and low pressure side of the assembly, wherein the filter element housing plate includes at least one circular array of female cavities, each configured to receive a replaceable filter element therein; and one replaceable filter element within each female cavity, each replaceable filter element including an endcap having integral external rounded polygon shaped sealing surface engaging peripheral surfaces of the female cavity of the filter element housing plate and sealing against peripheral surfaces of the female cavity of the filter element housing plate.

One aspect of the invention provides filter assembly includes a cylindrical filter housing; a filter element housing plate positioned between a high pressure and a low pressure side of the filter housing, the filter element housing plate having a plurality of one female cavities; and a plurality of replaceable filter elements within the filter housing, each replaceable filter element having an endcap with an external rounded polygon shaped sealing surface engaging peripheral surfaces of an associated female cavity of the filter element housing plate and sealing against peripheral surfaces of the female cavity of the filter element housing plate

These and other advantageous aspects of the invention will be clarified in connection with the attached figures in which like reference numerals represent like elements throughout.

### BRIEF DESCRIPTION OF THE DRAWINGS

FIG. 1 is a schematic perspective view of filter assembly with the ends thereof removed for clarity to show a filter element housing plate positioned between a high pressure and low pressure side of the assembly according to one embodiment of the present invention and one filter element mounted in the filter element housing plate;

FIG. 2 is a plan view of the filter element housing plate of FIG. 1;

FIG. 3 is a top perspective view of an endcap having integral external rounded polygon shaped sealing surface configured for engaging peripheral edges of one female cavity of the filter element housing plate of FIG. 1;

FIG. 4 is a sectional view of a filter element mounted within a female cavity of the filter element housing plate of FIG. 1;

FIG. 5 is an enlarged view of one filter element mounted in the filter element housing plate of FIG. 1; and

FIG. 6 is a schematic perspective view of filter assembly with one of the ends thereof removed for clarity to show a filter element housing plate positioned between a high pressure and low pressure side of the assembly according to a modified embodiment of the present invention having only a single filter element.

### BRIEF DESCRIPTION OF THE PREFERRED EMBODIMENTS

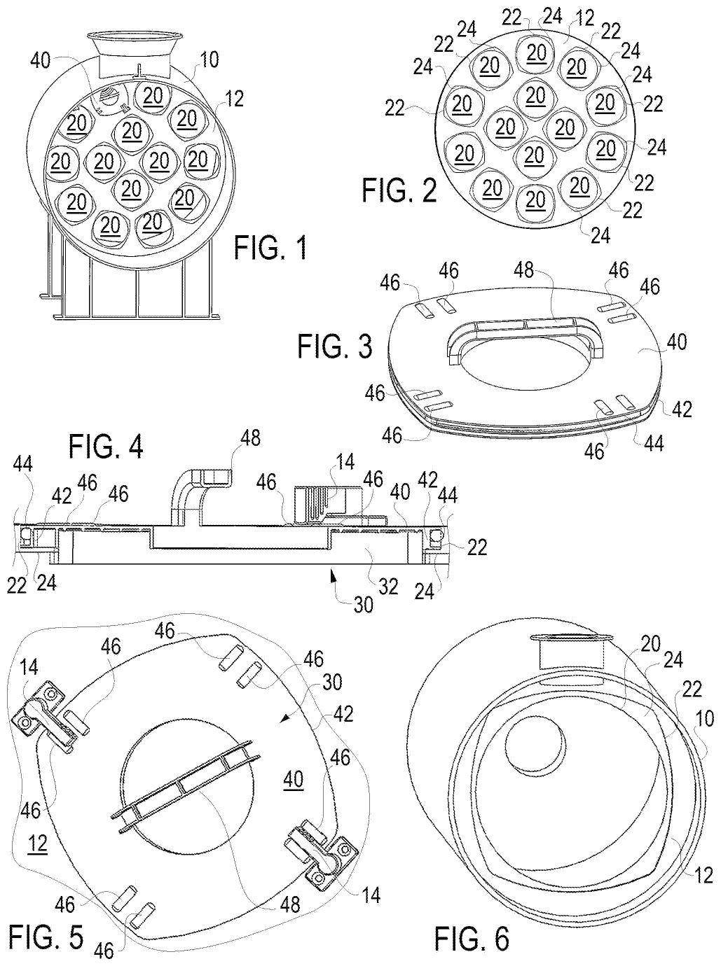

This invention is directed to a cost effective, efficient, filter assembly 10 which in one embodiment includes fourteen filter elements 30 arranged in parallel therein. The filter assembly includes a housing and also includes a common inlet and outlet for the assembly 10 which may be on the top of the cylindrical housing, one of which is shown in FIG. 1, or in the end (shown in FIG. 6) as generally known in the art. The peripheral shape of the assembly 10 is not critical and may vary depending upon the space limitations associated with the application and with the flow parameters within the assembly 10. Where space is not a significant consideration then the cylindrical housing arrangement shown, with supports as shown is a simple construction that allows for even flow through the apparatus 10.

The filter assembly 10 of one embodiment of the invention is shown in FIGS. 1-5 and includes a filter element housing plate 12 within the assembly 10 and in a position to separate the high pressure and low pressure sides of the assembly 10. The housing plate 12 defines the location of each replaceable filter element 30 with a female cavity 20. In the embodiment shown there is an outer array of ten cavities 20 and an inner array of four cavities 20 for a total of fourteen cavities for receiving fourteen replaceable filter elements 30.

It is possible to utilize less filter elements 30 than cavities 20 in the assembly 10 if, in operation, the remaining cavities 20 that do not include a filter element 30 are sealed with a cover plate (not shown) that would be similar to the end caps 40 discussed below but without an opening there through and no associated filter element 30.

The replaceable filter elements 30 of the present invention include desired filter media 32 between an upper endcap 40 and a lower endcap (not shown) and can include conventional bypass valve structure. The key aspects of the present invention relate to the upper endcap 40 structure having integral external rounded polygon shaped sealing surface 42. A rounded polygon is preferred, but other shapes like a unique ellipse or oval are possible. Unique rounded shapes that avoid inflection points can be utilized if desired. The avoiding of inflection points is because a star shaped profile, for example, would include such inflection points in the perimeter, would require a distinct sealing member to accommodate the complex concave and convex outer structure. Again a rounded rectangular or square shape as shown is preferred.

The upper endcap structure having integral external rounded polygon or square shaped sealing surface 42 is sized to fit into the complementary female cavities 20 of the housing plate 10 and have an outer O-ring 44 on the surface 42 seal against a side 22 of the female cavity and a bottom of the structure of the sealing surface 42 rest upon a bottom ledge 24 of the cavity 20.

The terms upper and lower and top and bottom used herein are relative to the individual components, because the components may ultimately be in any orientation based upon the positioning of the assembly 10, which as shown may have the filter elements 30 extending generally horizontally (thus the end caps of the elements 30 thereof would be orientated in the assembly 10 distal and proximal to one end rather than upper and lower, and the “bottom ledge” 24 of each cavity would similarly be more accurately described as proximal or distal to a given end of the assembly). The relative terms used herein are believed to be more easily understood by those of ordinary skill in the art.

The current design of the assembly 10 replaces the filter element sealing components, namely the sealing surface 42 structure including the radial O-ring 44 on the endcap 40, with every filter element 30 change thereby preventing unwanted leakage and improving performance over time. Namely the seal is replaced with every filter element 30 change.

The rounded polygon shape (square as shown) prevents unwanted twisting during installation as often occurs with a circular coupling, as users can sometime try and “spin” the element into position causing unintended stresses on the sealing components. The male configuration and polygon shape of sealing surface 42 structure of the end cap 40 both help align the replaceable filter element 30 during replacement and keep it properly aligned during installation. The sealing components forming the sealing structure 42 of the current male configuration of the replaceable filter element 30 is less likely to be damaged due to misalignment at installation than the sealing surfaces of a female bushing of earlier versions. In other words a misalignment in the prior version can damage the sealing surface, but in the present design the actual sealing elements are not likely to be engaged in any misalignment issues. Further, it is possible that the polygon shape can allow the filter element designers to maintain a specific preset desired rotational orientation of the filter element 20 to the housing of assembly 10 giving the designers greater flexibility in designing operational characteristics of the filter element 30 including unique internal flow paths and bypass location and operation.

The housing plate 12 includes at least two latches 14 for each filter element 30 that engage with and secure onto mating elements 46 formed onto the endcap 40 to secure the latches 14 in position holding the filter element 30 within the housing plate 10. The mating elements 46 on the endcap 40 prevent fluid flow within the assembly 10 from causing the undesired unlatching of the filter element 30 in use. The mating elements 46 are position on the end cap 40 at the “corners” and positioned such that they align with the latches 14 in any of four positions that the element 30 is inserted.

Finally the endcap 40 includes a handle 48 to assist in installing and removing the endcap 40 and associated filter element 30.

This invention is directed to a cost effective, efficient, filter assembly 10 which includes any number of filter elements 30 from one to fourteen as shown (or theoretically any number desired). It is preferred that the housing plate 12 be constructed with the number of cavities 20 equal to the specific number of filter elements desired to optimize filter element placement from a flow and performance standard, however, as noted above it is possible to utilize less filter elements 30 than cavities 20 in the assembly 10 if, in operation, the remaining cavities 20 that do not include a filter element 30 are sealed with a cover plate (not shown) that would be similar to the end caps 40 but without an opening there through and no associated filter element 30

As shown in FIG. 6, the filter assembly 10 according to the invention may include a housing plate 12 configured for a single replaceable filter element 30 as shown (with latches removed).

The housing plate 12 is an effective and efficient method of forming the apparatus 10 of the invention and separating the high pressure side and the low pressure side for the filter assembly 10. For a single element version the plate 12 may be replaced with, or formed as, a porting block of the housing rather than a plate member, which structure is the equivalent of a plate for the purpose of this application in the single element 30 version.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A filter assembly comprising:
A housing assembly having an inlet on a high pressure side and an outlet on a low pressure side;
a filter element housing plate positioned vertically within the housing assembly and between the high pressure side and the low pressure side of the housing assembly and the filter element housing plate having at plurality of female cavities, wherein each female cavity includes a radially inwardly facing peripheral side surface having a rounded polygon shape and a ledge adjacent a distal end of the peripheral side surface extending radially inward of the radially inwardly facing peripheral side surface;
a plurality of replaceable filter elements extending horizontally within the housing assembly, each replaceable filter element positioned within one of the female cavities of the filter element housing plate and having a proximal endcap with filter media extending distally from the proximal endcap, wherein the proximal endcap includes an external rounded polygon shaped sealing surface engaging the radially inwardly facing peripheral side surface of the one female cavity of the filter element housing plate and sealing against the radially inwardly facing peripheral side surface of the one female cavity of the filter element housing plate, wherein the ledge adjacent a distal end of the peripheral side surface of the one female cavity provides a stop for the horizontal movement of the replaceable filter element.

2. The filter assembly according to claim 1 wherein the housing assembly is cylindrical with vertical supports.

3. The filter assembly according to claim 2 wherein each external rounded polygon shaped sealing surface of each end cap includes an outer O-ring seal against a side of the female cavity.

4. The filter assembly according to claim 3 wherein each endcap having integral external rounded polygon shaped sealing surface has a distal end adjacent the ledge of the one female cavity.

5. The filter assembly according to claim 4 wherein the housing plate includes at least one latch for each filter element that engage with and secures onto the endcap of the filter element to secure replaceable filter element in position. .

6. The filter assembly according to claim 5 wherein each endcap includes a mating element configured to engage with and secure the latch in an operative position.

7. The filter assembly according to claim 6 wherein each endcap includes a handle for holding, installing and removing the replaceable filter element.

8. A filter assembly comprising:
A housing assembly having an inlet on a high pressure side and an outlet on a low pressure side;
a filter element housing plate vertically positioned between the high pressure and low pressure side of the housing assembly, wherein the filter element housing plate includes at least one circular array of female cavities, each configured to receive a replaceable filter element therein, wherein each female cavity includes a radially inwardly facing peripheral side surface having a rounded polygon shape and a ledge adjacent a distal end of the peripheral side surface extending radially inward of the radially inwardly facing peripheral side surface;
one replaceable filter element within each female cavity extending horizontally within the housing assembly, each replaceable filter element including a proximal endcap with filter media extending distally from the proximal endcap and having an integral external rounded polygon shaped sealing surface engaging the radially inwardly facing peripheral side surface of the female cavity of the filter element housing plate and sealing against the radially inwardly facing peripheral side surface of the female cavity of the filter element housing plate.

9. The filter assembly according to claim 8 wherein the filter element housing plate includes an inner array of four female cavities and outer array of female cavities.

10. The filter assembly according to claim 9 wherein each endcap has an outer O-ring seal against the radially inwardly facing peripheral side surface of the female cavity of the filter element housing plate.

11. The filter assembly according to claim 10 wherein the housing plate includes at least one latch for each filter element that engage with and secures onto the endcap to secure replaceable filter element in position.

12. The filter assembly according to claim 11 wherein each endcap includes a mating element configured to engage with and secure the latch in an operative position.

13. The filter assembly according to claim 12 wherein each endcap includes a handle for holding, installing and removing the replaceable filter element.

14. A filter assembly comprising:
a cylindrical filter housing;
a filter element housing plate positioned vertically between a high pressure and a low pressure side of the filter housing, the filter element housing plate having a plurality of female cavities, wherein each female cavity includes a radially inwardly facing peripheral side surface having a rounded polygon shape and a ledge adjacent a distal end of the peripheral side surface extending radially inward of the radially inwardly facing peripheral side surface ;;
a plurality of replaceable filter elements extending horizontally within the housing assembly, each replaceable filter element positioned within one of the female cavities of the filter element housing plate and having a proximal endcap with filter media extending distally from the proximal endcap, wherein the proximal endcap includes an external rounded polygon shaped sealing surface engaging the radially inwardly facing peripheral side surface of the one female cavity of the filter element housing plate and sealing against the radially inwardly facing peripheral side surface of the one female cavity of the filter element housing plate, wherein the ledge adjacent a distal end of the peripheral side surface of the one female cavity provides a stop for the horizontal movement of the replaceable filter element.

15. The filter assembly according to claim 14 wherein each endcap has an outer O-ring seal against the radially inwardly facing peripheral side surface of the one female cavity of the filter element housing plate.

16. The filter assembly according to claim 15 wherein the cylindrical housing has two vertical supports and an inlet and outlet offset ninety degrees.

17. The filter assembly according to claim 15 wherein the housing plate includes at least one latch for each filter element that engage with and secures onto the endcap of the filter element to secure replaceable filter element in position. .

18. The filter assembly according to claim 17 wherein each endcap includes a mating element configured to engage with and secure the latch in an operative position.

19. The filter assembly according to claim 15 wherein each endcap includes a handle for holding, installing and removing the replaceable filter element.

20. The filter assembly according to claim 19 wherein the filter element housing plate includes an inner and outer array of female cavities.
